(19) United States
(12) Patent Application Publication
(10) Pub. No.: US 2009/0033793 A1
(43) Pub. Date: Feb. 5, 2009

(54) TELEVISION RECEIVER AND TELEVISION DISPLAY METHOD

(75) Inventor: Takahiro Kimura, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/117,137

(22) Filed: May 8, 2008

(30) Foreign Application Priority Data
Jul. 31, 2007 (JP) 2007-199919

(51) Int. Cl. H04N 5/46

(52) U.S. Cl. 348/555; 348/E05.114

(57) ABSTRACT

According to one embodiment, a television receiver comprises a reception unit configured to receive, from each of external instruments connected to a television receiver, standard information indicating whether or not the external instrument meets interdependent controllability standards and instrument type information specifying the type of the external instrument, a recording unit configured to record the standard information and the instrument type information, in association with each of the external instruments, a display unit configured to display video information from any of the external instruments, and a control unit configured to, when a selection unit selects a particular one of the external instruments, controllably display video information from the particular external instrument on the display unit using a preset first video adjustment value and a preset first screen adjustment value.

### CROSS-REFERENCE TO RELATED APPLICATIONS

This application is based upon and claims the benefit of priority from Japanese Patent Application No. 2007-199919, filed Jul. 31, 2007, the entire contents of which are incorporated herein by reference.

### BACKGROUND

1. Field

One embodiment of the invention relates to a television receiver that acquires various pieces of information from external instruments connected to the television receiver, as well as a television display method.

2. Description of the Related Art

As is well known, digitalization of television broadcasting has recently been promoted. For example, in Japan, in addition to satellite digital broadcasting such as BS (Broadcasting Satellite) digital broadcasting and 110-degree CS (Communication Satellite) digital broadcasting, terrestrial digital broadcasting has been started. A television receiver that receives these broadcastings connects to PC, a mobile instrument, an AV instrument, or the like via a network. A CEC (Consumer Electronics Control)-compatible external instrument connected to the television receiver via an HDME (High Definition Multimedia Interface) terminal can be operated in conjunction with the television receiver by operating the television receiver via a remote controller or the like.

The use of such a multifunctional television receiver has resulted in the prevalence of a lifestyle in which a user connects PC to the television receiver to display video information output by PC on a large screen of the television receiver to view the video information on the screen.

Jpn. Pat. Appln. KOKAI Publication No. 2006-107014 discloses a configuration which, when a screen of PC is displayed on the television receiver connected to PC, acquires setting information required to control the display on the television receiver to display, on the television receiver, dialogs allowing the user to check the display status of the television receiver connected to PC.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of an information communication terminal and peripheral instruments according to a first embodiment of the invention;

FIG. 2 is an exemplary block diagram showing the internal configuration of the information communication terminal in the embodiment;

FIG. 3 is an exemplary diagram illustrating the appearance of a remote controller for the information communication terminal in the embodiment;

FIG. 4 is an exemplary flowchart illustrating how the information communication terminal in the embodiment;

FIG. 5 is an exemplary diagram showing a video display of the information communication terminal in the embodiment; and

FIG. 6 is an exemplary diagram showing the video display of the information communication terminal in the embodiment.

### DETAILED DESCRIPTION

Various embodiments according to the invention will be described hereinafter with reference to the accompanying drawings. In general, according to one embodiment of the invention, a television receiver comprises a connection unit configured to connect the television receiver to external instruments via a network, a reception unit configured to receive, from each of the external instruments connected to the television receiver by the connection unit, standard information indicating whether or not the external instrument unit interdependent controllability standards and instrument type information specifying the type of the external instrument, a recording unit configured to record the standard information and the instrument type information received by the receiving unit configured to, in association with each of the external instruments, a display unit configured to display video information from any of the external instruments, a selection unit configured to select one of the external instruments which is to be an output source of video information to be displayed on the display unit, and a control unit configured to, when the selection unit selects a particular one of the external instruments, controllably display video information from the particular external instrument on the display unit using a preset first video adjustment value and a preset first screen adjustment value.

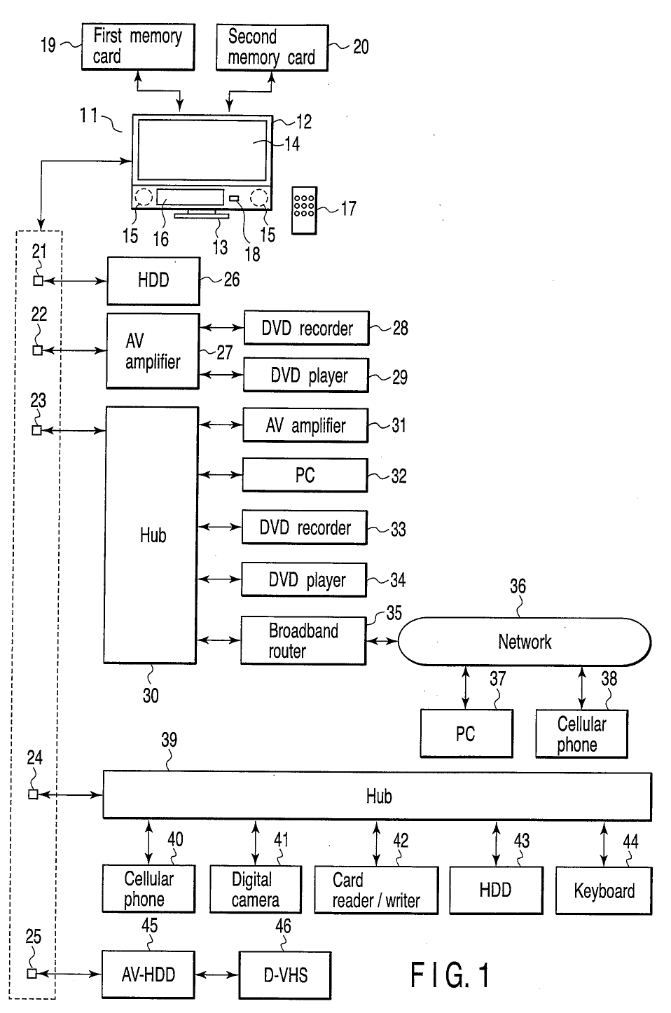

An embodiment of the invention will be described below in detail with reference to the drawings. FIG. 1 schematically shows the appearance of an information communication terminal 11 described in the embodiment and an example of a network system centered around the information communication terminal 11.

The information communication terminal 11 (for example, a digital television receiver) is mainly composed of a thin cabinet 12 and a support 13 that supports the cabinet upright. A flat panel video display 14, a speaker 15, an operation section 16, a light receiving section 18, and the like are installed in the cabinet 12; the video display 14 is made up of, for example, a liquid crystal display panel, and the light receiving section 18 receives operational information transmitted by a remote controller 17.

A first memory card 19, for example, an SD (Secure Digital) memory card or MMC (MultiMedia Card), can be installed in and removed from the information communication terminal 11. Information such as programs or photographs is recorded in and reproduced from the first memory card 19.

A second memory card [IC (Integrated Circuit) card] 20 can also be installed in and removed from the information communication terminal 11, and contains a semiconductor memory in which, for example, contract information is recorded. Information is recorded in and reproduced from the second memory card 20.

The information communication terminal 11 also comprises a LAN (Local Area Network) terminal 21, a first HDMI terminal 22, a second HDMI terminal 23, a USB (Universal Serial Bus) terminal 24, and an i. LINK terminal 25.

The LAN terminal 21 can be used as a LAN-compatible HDD (Hard Disk Drive). The LAN terminal 21 is used to record and reproduce information, via Ethernet (registered trade mark), in and from LAN-compatible HDD 25, which is a connected NAS (Network Attached Storage). The LAN terminal 21 as a port dedicated for LAN-compatible HDD enables information on programs with high vision image quality to be stably recorded in HDD 26 without being affected by other network environments, network use status, or the like.

A common LAN-compatible port using Ethernet (registered trade mark) can also be used as the LAN terminal 22. In this case, instruments such as LAN-compatible HDD, PC (Personal Computer), HDD incorporated DVD recorder, and the like are connected to the LAN terminal 22, for example, via a hub so that information can be transmitted between the instruments and the LAN terminal 22.

External instruments including a DVD recorder 28 and a DVD player 29 are connected to the first HDMI terminal 22 via an AV amplifier 27.

External instruments such as an AV amplifier 31, PC (Personal Computer) 32, an HDD incorporated DVD recorder 33, and a DVD player 34 are connected to the second HDMI terminal 22, for example, via a hub 30 and used to allow information to be transmitted between the instruments and the second HDMI terminal 23. The first HDMI terminal 22 and the second HDMI terminal 23 transmit and receive information to and from the external instruments in a form conforming to HDMI standards.

Moreover, the second HDMI terminal 23 is connected to a network 36, for example, the Internet, via a broadband router 35 connected to the hub 30 and used to allow information to be transmitted to and received from PC 37, a cellular phone 38, and the like via the network 36.

The USB terminal 24 is used as a common USB compatible port and connects to, for example, a cellular phone 40, a digital camera 41, a card reader/writer 42 for a memory card, HDD 43, a keyboard 44, and the like via a hub 39 and used to allow information to be transmitted to and received from these USB instruments.

The i. LINK terminal 25 connects to, for example, AV-HDD 45 and D (Digital)-VHS (Video Home System) 46 and connects serially to a terrestrial digital tuner (not shown), and used to allow information to be transmitted to and received from these instruments.

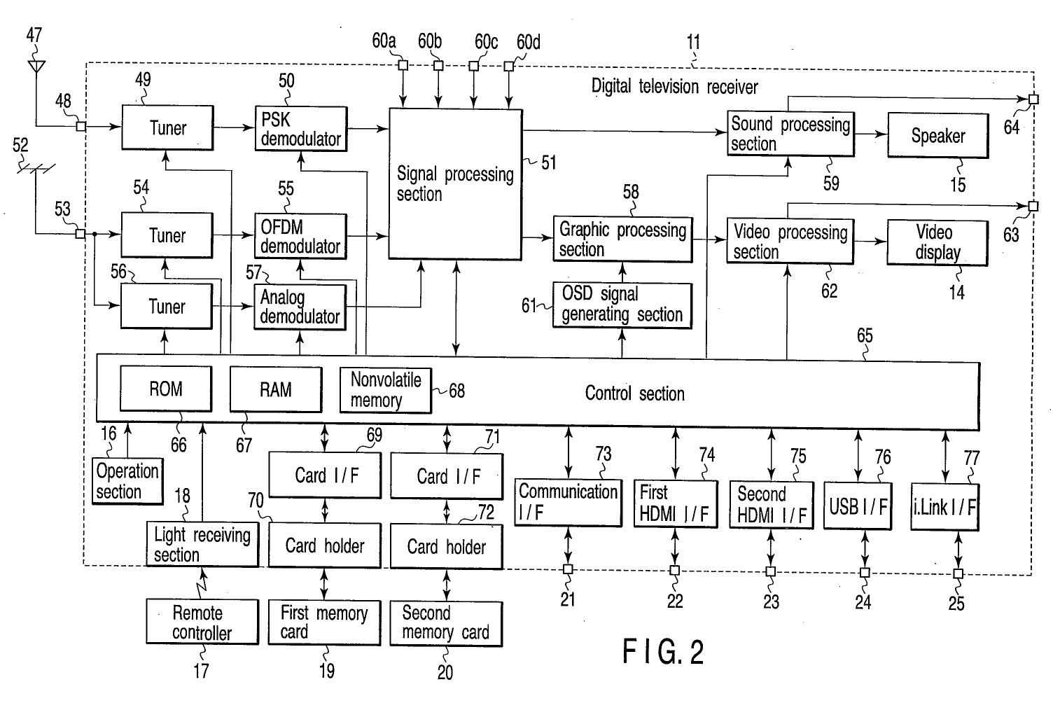

FIG. 2 shows main signal processing systems in the digital television broadcasting receiver 11. A satellite digital television broadcasting signal received by a BS/CS digital broadcasting receiving antenna 47 is supplied to a satellite digital broadcasting tuner 49 via an input terminal 48 to select a broadcasting signal for a desired channel.

The broadcasting signal selected by the tuner 49 is then supplied to a PSK (Phase Shift Keying) demodulator 50, demodulated into a digital video signal and a digital audio signal, and output to a signal processing section 51.

A terrestrial digital television broadcasting signal received by a terrestrial digital broadcasting receiving antenna 52 is supplied to a terrestrial digital broadcasting tuner 54 via an input terminal 53 to select a broadcasting signal for a desired channel.

The broadcasting signal selected by the tuner 54 is then supplied to an OFDM (Orthogonal Frequency Division Multiplexing) demodulator 55, demodulated into a digital video signal and a digital audio signal, and output to the signal processing section 51.

A terrestrial analog television broadcasting signal received by the terrestrial digital broadcasting receiving antenna 52 is supplied to a terrestrial analog broadcasting tuner 56 via the input terminal 53 to select a broadcasting signal for a desired channel. The broadcasting signal selected by the tuner 56 is then supplied to an analog demodulator 57, demodulated into an analog video signal and an analog audio signal, and output to the signal processing section 51.

The signal processing section 51 selectively executes predetermined digital signal processing on the digital video signal and audio signal supplied by each of the PSK demodulator 50 and OFDM demodulator 55 and output the resulting signals to a graphic processing section 58 and a sound processing section 59, respectively.

A plurality of (in the figures, four) input terminals 60a, 60b, 60c, and 60d are connected to the signal processing section 51. The input terminals 60a to 60d allow external instruments to input analog video and audio signals to the digital television broadcasting receiver 11.

The signal processing section 51 selectively digitalizes the analog video and audio signals supplied by the analog demodulator 57 and the input terminals 60a to 60d, executes predetermined digital signal processing on the digitalized video and audio signals, and outputs the resulting video and audio signals to the graphic processing section 58 and the sound processing section 59.

The graphic processing section 58 has a function of superimposing an OSD signal generated by an OSD (On Screen Display) signal generating section 61 on the digital video signal supplied by the signal processing section 51. The graphic processing section 54 can selectively output the output video signal from the signal processing section 51 and the output OSD signal from the OSD signal generating section 61 and can combine these output signals together so that each of the output signals constitutes half of a screen.

The digital video signal output by the graphic processing section 58 is supplied to a video processing section 62. The video processing section 62 converts the input digital video signal into an analog video signal in a format enabling the signal to be displayed on the video display 14. The video processing section 62 then outputs the analog video signal to the video display 14 for display and also directs the signal to an external instrument via the output terminal 63.

The sound processing section 59 converts the input digital audio signal into an analog audio signal in a format enabling the signal to be reproduced by the speaker 15. The sound processing section 59 then outputs the analog audio signal to the speaker 15 for sound reproduction and also directs the signal to an external instrument via the output terminal 64.

A control section 65 integrally controls all the operations of the digital television broadcasting receiver 11 including the various receiving operations described above. The control section 65 contains CPU (Central Processing Unit) and the like and receives operational information from the operation section 16 or operational information transmitted by the remote controller 17 and received via the light receiving section 18 to control the appropriate sections so as to reflect the contents of the operations.

In this case, the control section 65 mainly utilizes ROM (Read Only Memory) 66 in which control programs executed by CPU are stored, RAM (Random Access Memory) 67 that provides a work area for CPU, and a nonvolatile memory 68 in which various pieces of setting information, control information, and the like are stored.

The control section 65 is connected, via a card I/F (interface) 69, to a card holder 70 in the first memory card 19 can be installed. The control section 65 can thus transmit information via the first memory card 19, installed in the card holder 70 and the card I/F 69.

The control section 65 is further connected, via a card I/F 71, to a card holder 72 in which the second memory card 20 can be installed. The control section 65 can thus transmit information via the second memory card 20, installed in the card holder 72 and the card I/F 71.

The control section 65 is connected to the LAN terminal 21 via a communication I/F 73. The control section 65 can thus transmit and receive information to and from LAN-compatible HDD 26, connected to the LAN terminal 21, via the communication I/F 73. In this case, the control section 65 has a DHCP (Dynamic Host Configuration Protocol) server function to assign an IP (Internet Protocol) address to LAN-compatible HDD 26, connected to the LAN terminal 21, for control.

The control section 65 is further connected to the first HDMI terminal 22 via a first HDMI I/F 74. The control section 65 can thus transmit and receive information to and from the instruments (see FIG. 1) connected to the first HDMI terminal 22, via the first HDMI I/F 74. The control section 65 is further connected to the second HDMI terminal 23 via a first HDMI I/F 75. The control section 65 can thus transmit and receive information to and from the instruments (see FIG. 1) connected to the second HDMI terminal 23, via the first HDMI I/F 75.

The control section 65 is connected to the USB terminal 24 via a USB I/F 76. The control section 65 can thus transmit and receive information to and from the instruments (see FIG. 1) connected to the USB terminal 24, via the USB I/F 76.

The control section 65 is further connected to the i. LINK terminal 25 via an i. LINK I/F 77. The control section 65 can thus transmit and receive information to and from the instruments (see FIG. 1) connected to the i. LINK terminal 25, via the i. LINK I/F 77.

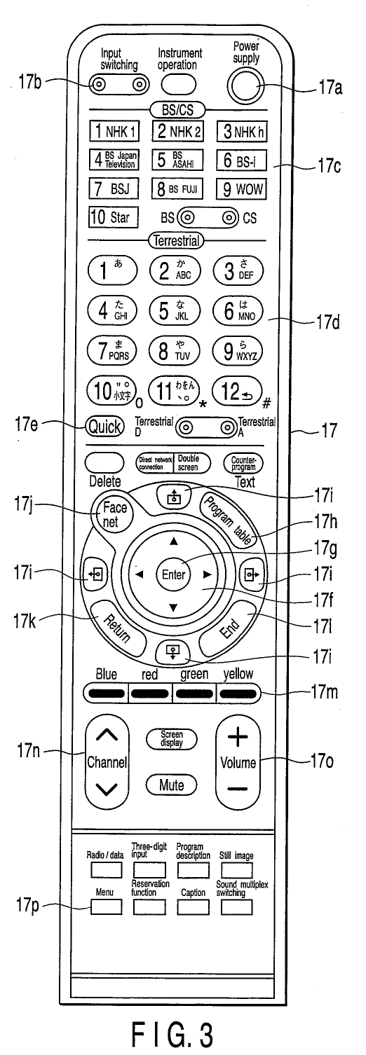

FIG. 3 shows the appearance of the remote controller 17. The remote controller 17 mainly has a power supply key 17a, an input switch key 17b, a direct select key 17c for satellite digital broadcasting channels, a direct select key 17d for terrestrial digital broadcasting channels, a quick key 17e, a cursor key 17f, an enter key 17g, a program table key 17h, a page switching key 17i, a face net (navigation) key 17j, a return key 17k, an end key 17l, a blue, red, green, and yellow color key 17m, a channel up down key 17n, a volume adjustment key 17o, and a menu key 17p.

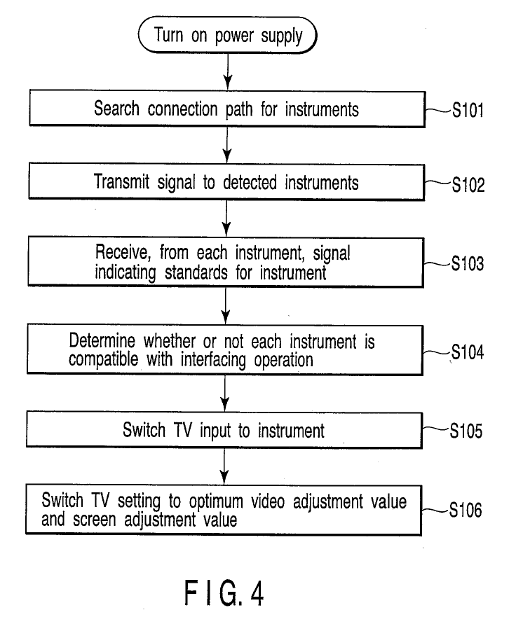

Now, with reference to a flowchart shown in FIG. 4, description will be given of the case in which PC 32 is connected to the information communication terminal 11 as an external instrument and in which video information output by PC 32 is displayed on the video display 14 of the information communication terminal 11.

As shown in FIG. 1, the plurality of external instruments is connected to each of the first HDMI terminal 22 and second HDMI terminal 23 of the information communicational terminal 11. Upon sensing operation of the power supply key 17a performed through the operation section 16 or the remote controller 17, the control section 65 activates the appropriate sections of the information communication terminal 11.

The control section 65 identifies the external instruments connected to the first HDMI terminal 22 and the second HDMI terminal 23 (step S101).

The control section 65 transmits a command to the external instruments connected to the first HDMI terminal 22 and the second HDMI terminal 23 to identify the external instruments connected to the information communication terminal 11 on the basis of the presence or absence of a response signal to the command signal.

At this time, each of the external instruments transmits a signal containing a logical address to the information communication terminal 11 at a predetermined timing. The logical address is defined as one of the numbers 0 to 15. Of the numbers 0 to 15, one number is set for the television receiver, three numbers are set for the recorders, three numbers are set for the players, one number is set for the AV amplifier, six numbers are set for the tuners, and the remaining numbers are set for the other instruments so that the different numbers correspond to the respective instrument types. The external instrument acquires one of the numbers which corresponds to that instrument and transmits the number to the information communication terminal 11.

When the information communication terminal 11 receives the signal transmitted by the external instrument and containing the logical address, the control section 65 determines the type of the external instrument transmitting the signal, on the basis of information on the correspondences between the logical addresses and the instrument types which information is recorded in the nonvolatile memory 68. Besides the logical addresses defined as 0 to 15, vender commands originally set by the corresponding venders may be used. In this case, the external instrument transmits the vender command corresponding to that instrument to the information communication terminal 11. When the information communication terminal 11 receives the vender command, the control section 65 determines the type of the external instrument transmitting the signal, on the basis of information on the correspondences between the vender commands and the instrument types which information is recorded in the nonvolatile memory 68. The instrument type is defined as an XXX (vender name) recorder or an XXX (vender name) player in accordance with the corresponding vender command.

To determine the connection relationship between the external equipment and the first HDMI terminal 22 or second HDMI terminal 23, the control section 65 defines instrument numbers for the external instruments.

If the control section 65 transmits a command to determine the presence or absence of external instruments connected to the first HDMI terminal 22 and the second HDMI terminal 23 and receives a response signal to the command via the first HDMI I/F 74, the control section 65 defines the external instrument connected to the first HDMI terminal 22 as number 1. If the control section 65 receives a response signal via the second HDMI I/F 75, the control section 65 defines the instrument number of external instrument connected to the second HDMI terminal 23 as 2.

The control section 65 records the instrument types and the like transmitted by the connected external instruments, in the nonvolatile memory 68 in association with the instrument numbers.

For example, if the plurality of instruments are connected in series with the first HDMI terminal 22 as shown in FIG. 1 and the control section 65 receives a plurality of response signals via the first HDMI I/F 74 or if the plurality of instruments are connected in parallel with second HDMI terminal 23 via the hub 30 and control section 65 receives a plurality of response signals via the first HDMI I/F 74, then the control section 65 sets the instrument numbers as follows.

The AV amplifier 27 is connected to the first HDMI terminal 22. The DVD recorder 28 and the DVD player 29, each having an HDMI terminal, are connected to input HDMI terminals provided in the AV amplifier 27.

The control section 65 further sets an instrument number 1-X (X is set to be any number) for all the instruments connected to the first HDMI terminal 22.

For example, the control section 65 sets 1-1 for the AV amplifier 27, 1-2 for the DVD recorder 28, and 1-3 for the DVD player 29. The control section 65 then records information contained in a signal transmitted by the AV amplifier 27, in the nonvolatile memory 68 in association with the instrument number 1-1. Similarly, the control section 65 records information contained in a signal transmitted by the DVD recorder 28, in the nonvolatile memory 68 in association with the instrument number 1-2. The control section 65 records information contained in a signal transmitted by the DVD player 29, in the nonvolatile memory 68 in association with the instrument number 1-3.

The control section 65 sets an instrument number 2-X (X is set to be any number) for all the instruments connected to the second HDMI terminal 23. For example, the control section 65 sets 2-1 for the AV amplifier 31, 2-2 for PC 32, 2-3 for the DVD recorder 33, and 2-4 for the DVD player 34. The control section 65 then records information contained in a signal transmitted by the AV amplifier 31, in the nonvolatile memory 68 in association with the instrument number 2-1. Similarly, the control section 65 then records information contained in a signal transmitted by PC 32, in the nonvolatile memory 68 in association with the instrument number 2-2. The control section 65 records information contained in a signal transmitted by the DVD recorder 33, in the nonvolatile memory 68 in association with the instrument number 2-3. The control section 65 records information contained in a signal transmitted by the DVD player 34, in the nonvolatile memory 68 in association with the instrument number 2-4. Each of the external instruments transmits type name information on that instrument to the information communication terminal 11. The control section 65 records the optionally set instrument numbers, the instrument types, and the type names in the nonvolatile memory 68 in association with one another.

The control section 65 then transmits, to each of the external instruments connected to the first and second HDMI terminals 22 and 23, a signal requesting the external instrument to inform the control section 65 of whether or not the instrument is compatible with CEC (step S102).

If the external instrument is compatible with CEC, the user can operate the information communication terminal 11 via the remote controller 17 utilizing an HDMI-CEC command, to operate the CEC-compatible external instrument in conjunction with the information communication terminal 11.

Then, on the basis of the signals returned by the external instruments connected to the first HDMI terminal 22 and the second HDMI terminal 23, the control section 65 determines whether or not each of the external instruments is compatible with CEC (step S103). The control section 65 then records HDMI input list information including HDMI information for all the external instruments, in the nonvolatile memory 68; the HDMI information contains the optionally set instrument numbers, the instrument types, the type names, and whether or not the external instrument is compatible with CEC (compatible with HDMI), which are associated with one another (step S104).

Here, the AV amplifier 31 is incompatible with CEC, PC 32 is compatible with CEC, the DVD recorder 33 is compatible with CEC, and the DVD player 34 is incompatible with CEC; the AV amplifier 31, PC 32, the DVD recorder 33, and the DVD player 34 are all connected to the second HDMI terminal 23 via the hub 30.

For example, for the AV amplifier 31, the instrument number is 2-1, the instrument type is an AV amplifier, the type name is DTX-5.8, and the AV amplifier 31 is compatible with CEC. Accordingly, the lack of the HDMI compatibility is recorded in the nonvolatile memory 68. For PC 32, the instrument number is 2-2, the instrument type is an XXX (vender name) PC, the type name is abcd-e10, and PC 32 is compatible with CEC. Accordingly, the presence of the HDMI compatibility is recorded in the nonvolatile memory 68. Similarly, the HDMI input list information is displayed for all the external instruments HDMI-connected to the information communication terminal 11. For the DVD recorder 33, the instrument number is 2-3, the instrument type is an XXX (vender name) recorder, the type name is RD-A600, and PC 32 is compatible with CEC. Accordingly, the presence of the HDMI compatibility is recorded in the nonvolatile memory 68. For the DVD player 34, the instrument number is 2-4, the instrument type is an XXX (vender name) player, the type name is HD-A2, and PC 32 is incompatible with CEC. Accordingly, the lack of the HDMI compatibility is recorded in the nonvolatile memory 68.

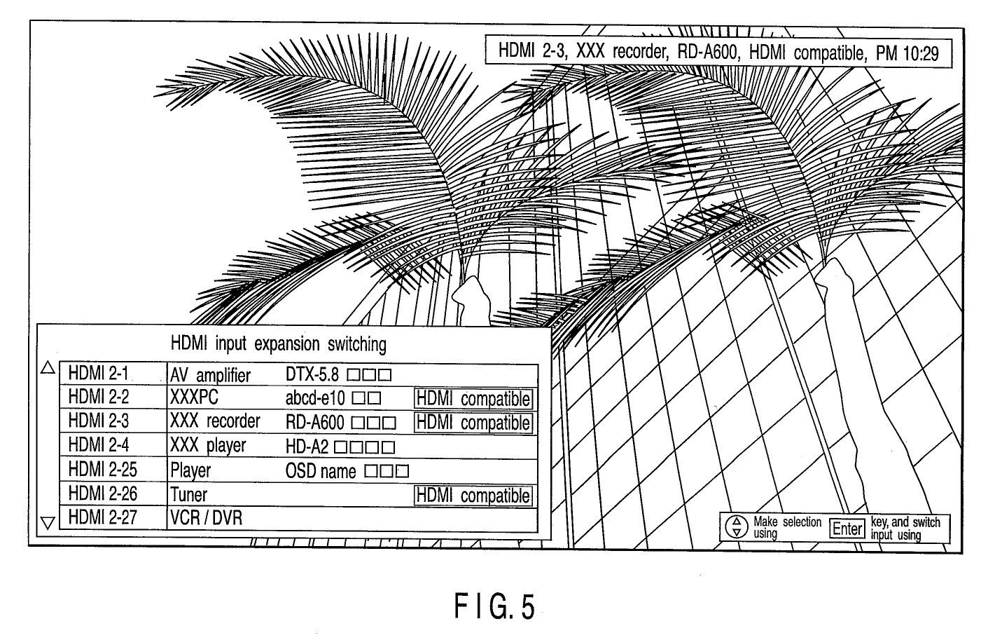

Upon sensing a predetermined operation performed by the remote controller 17, the control section 65 can read HDMI input list information such as that shown in FIG. 5, from the nonvolatile memory 68 and display the information on the video display 14.

The HDMI input list information contains the instrument number, the instrument type, the type name, and whether or not the instrument is compatible with HDMI, in this order; specifically, the video display 14 displays (2-1, AV amplifier, DTX-5.8, HDMI compatible), (2-2, XXX (vender name) PC, abcd-e10, HDMI compatible), (2-3, XXX (vender name) recorder, RD-A600, HDMI compatible), and (2-4, XXX (vender name) player, HD-A2). When the instrument is compatible with HDMI, “HDMI compatible” is displayed. When the instrument is incompatible with HDMI, “HDMI compatible” is not displayed.

On a display screen for the HDMI input list information, the user can use the cursor key 17f on the remote controller 17 to select a desired external instrument the input signal from which is to be displayed on the video display 14. Upon sensing that the user uses, on the display screen for the input list information, the enter key 17g on the remote controller 17 to input the HDMI information on the desired external instrument, the control section 65 displays the input signal from the external instrument on the display screen of the video display 14. The control section 65 also acquires the corresponding HDMI information on the external instrument from the nonvolatile memory 68 for display.

When, for example, the user selects a section with the instrument number 2-3 from the HDMI input list information so as to allow video information output by the DVD recorder 33 to be displayed on the video display 14, the control section 65 controllably displays the video information transmitted by the DVD recorder 33 on the video display 14. The control section 65 further displays the HDMI information on the DVD recorder 33 at any position on the video display 14 (for example, the upper right end of the display 14 as shown in FIG. 5).

At this time, as shown in FIG. 5, the control section 65 visibly displays 2-3 as an instrument number, XXX (vender name) recorder as an instrument type, RD-A600 as a type name, and “HDMI compatible”, as the HDMI information on the DVD recorder 33 acquired from the HDMI input list information recorded in the nonvolatile memory 68.

Upon sensing the predetermined operation performed by the remote controller 17, the control section 65 can read the HDMI input list information from the nonvolatile memory 68 and display the information on the video display 14 as shown in FIG. 5.

The HDMI input list information contains the instrument number, the instrument type, the type name, and whether or not the instrument is compatible with HDMI, in this order; specifically, the video display 14 displays (2-1, AV amplifier, DTX-5.8, HDMI compatible), (2-2, XXX (vender name) PC, abcd-e10, HDMI compatible), (2-3, XXX (vender name) recorder, RD-A600, HDMI compatible), and (2-4, XXX (vender name) player, HD-A2). When the instrument is compatible with HDMI, the letters “HDMI compatible” are displayed. When the instrument is incompatible with HDMI, the letters “HDMI compatible” are not displayed.

On the display screen for the HDMI input list information, the user can use the cursor key 17f on the remote controller 17 to select a desired external instrument the video information from which is to be displayed on the video display 14. Upon sensing that the user uses, on the display screen for the input list information, the enter key 17g on the remote controller 17 to input the HDMI information on the desired external instrument, the control section 65 displays a video signal output by the selected external instrument on the display screen of the video display 14. The control section 65 also acquires the corresponding HDMI information on the external instrument from the nonvolatile memory 68 for display.

It is assumed that, on the screen for the HDMI input list information shown in FIG. 5, the user selects the HDMI information corresponding to PC 32, (2-2, XXX (vender name) PC, abcd-e10, HDMI compatible). The control section 65 switches the video displayed on the video display 14 to the video information output by PC 32 (step S105).

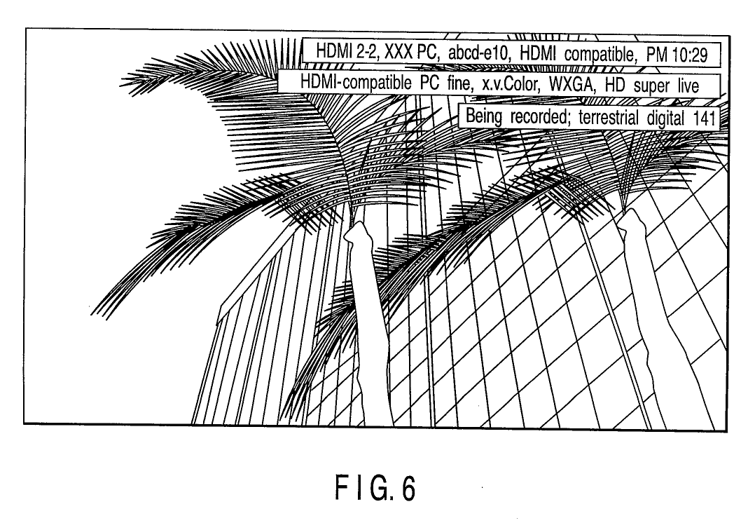

In displaying the video information output by PC 32 on the video display 14, the control section 65 controllably switches a video adjustment value and a screen adjustment value to optimum ones for output (step S106). FIG. 6 shows a screen display obtained when the video information output by PC 32 is displayed on the video display 14.

The optimum video adjustment value can be optionally set in accordance with an environment in which the information communication terminal 11 is installed and the video information displayed on the video display 14 of the information communication terminal 11. The user uses the menu key 17p on the remote controller 17 to instruct the information communication terminal 11 to display a video mode select display screen. The control section 65 then reads and displays the video mode select display screen recorded in the nonvolatile memory 68, on the video display 14.

The video modes include, for example, a clear mode, a standard mode, a movie mode, a game mode, and a PC fine mode. The clear mode is suitable when the display of the information communication terminal 11 is viewed in a bright environment. The standard mode is suitable when the display of the information communication terminal 11 is viewed in a normal environment. The movie mode is suitable when a movie displayed on the information communication terminal 11 is viewed in a dark environment. The game mode is suitable when a game is played on the information communication terminal 11 because in the game mode, video information from a game machine connected to the information communication terminal 11 as an external instrument is displayed on the video display 14 of the information communication terminal 11 with a reduced time lag. The PC fine mode is suitable when video information from PC 32 is viewed on the video display 14 because the PC fine mode allows brightness, colors, and contrast to be adjusted when externally connected PC 32 outputs video information such as letters. The control section 65 controls the video processing section 62 so that the video processing section 62 converts the video information into a display format corresponding to the selected video mode.

The screen adjustment value can be optionally set in accordance with the video displayed on the video display 14 of the information communication terminal 11. The user uses the menu key 17p on the remote controller 17 to instruct the information communication terminal 11 to display the video mode select display screen. The control section 65 then reads and displays the video mode select display screen recorded in the nonvolatile memory 68, on the video display 14.

Screen display modes include an over scan mode and a just scan mode. The over scan mode is suitable when a satellite digital television broadcasting signal received by the BS/CS digital broadcasting receiving antenna 47 or a terrestrial digital television broadcasting signal received by the terrestrial broadcasting receiving antenna 52 is displayed on the video display 14 via the signal processing section 51 or the like or when video information reproduced by the DVD player 34 is displayed on the video display 14. These pieces of video information contain information other than videos, for example, at an upper end of image data. Thus, the video information displayed on the video display 14 is scaled down to 90% so as to prevent the user from feeling uncomfortable with the display.

In contrast, the just scan mode is suitable when the video information output by PC 32 is displayed on the video display 14. Unlike video information contained in signals received by the antennas 47 and 52, the video information output by PC 32, when displayed on the video display 14 in the over scan mode, has an outer frame in the information eliminated. Thus, the video display 14 needs to display the video information at 100% scaling. The control section 65 thus controls the video processing section 62 so that the video processing section 62 converts the video information into the display format corresponding to the selected screen display mode.

Since the control section 65 switches the video displayed on the video display 14 to the video information output by PC 32, the optimum video adjustment value in this case belongs to the PC fine mode as the video mode, and the optimum image adjustment value belongs to the just scan mode as the image display mode.

The control section 65 has the HDMI input list information stored in the nonvolatile memory 68. Thus, upon sensing that the HDMI information (2-2, XXX (vender name) PC, abcd-e10, HDMI compatible) has been selected, the control section 65 determines that the video information to be displayed on the video display 14 has been output by PC 32. In this case, the following information is recorded in ROM 66 or the nonvolatile memory 68 before shipment of the information communication terminal 11 or by the user's setting: the optimum video adjustment value for the video information output by PC 32 belongs to the PC fine mode as the video mode, and the optimum image adjustment value belongs to the just scan mode as the image display mode. The control section 65 thus controls the video processing section 62 so that the video display 14 displays the video information output by PC in the display format corresponding to the PC fine mode as the video mode and the just scan mode as the image display mode as shown in FIG. 6.

Thus, upon performing switching such that the video information output by PC 32 is to be displayed on the video display 14, the user no longer needs to perform manual switching otherwise required to set the optimum video mode and image display mode. The video information is thus displayed on the video display 14 in the optimum display format without the need for the user to execute any processing. This improves the user's convenience.

The control section 65 then displays a text on the video display 14 showing that the video mode in which the video information output by PC is displayed is the PC fine mode as shown in FIG. 6. The user can thus easily visually recognize that the video information output by PC is displayed on the video display 14 in the optimum video mode. This reduces complicatedness associated with the user's handling of the video mode.

In the above description, the switching is performed such that the video information output by PC 32 is displayed on the video display 14. The description also applies to the case in which a game machine is connected to the first HDMI terminal 22 as an external instrument and in which the control section 65 acquires HDMI information from the game machine. That is, if the user selects switching such that the video information output by the game machine is displayed on the video display 14, the control section 65 can sense that the game machine has been selected and control the video processing section 62 so that the video mode is switched to the game mode for display.

The above processing executed by the control section 65 is similarly executed on the instruments each connected to any of the terminals other than the first HDMI terminal 22 and the second HDMI terminal 23, that is, the LAN terminal 21, the USB terminal 24, and the i. LINK terminal 25, and having a function similar to CEC.

As described above, when there are a plurality of moving image stream data files generated for one title, the CPU 114 can easily determine which moving image stream files forms one title, based on file names of moving image stream files and the file structure. This structure eliminates the need for accessing the moving image information data file each time to read information for determination, and thus contributes to increased efficiency in processing.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A television receiver comprising:
a connection unit configured to connect the television receiver to external instruments via a network;
a reception unit configured to receive, from each of the external instruments connected to the television receiver by the connection unit, standard compatibility information indicating whether or not the external instrument meets interdependent controllability standards and instrument type information specifying the type of the external instrument;
a recording unit configured to record the standard compatibility information and the instrument type information received by the receiving unit, in association with each of the external instruments;
a display unit configured to display video information output by any of the external instruments;
a selection unit configured to select any of the external instruments connected to the connection unit as an output source of video information to be displayed on the display unit; and
a control unit configured to, when the selection unit selects a particular external instrument, controllably display video information from the particular external instrument on the display unit using a preset first video adjustment value and a preset first screen adjustment value.

2. The television receiver according to claim 1, wherein when the selection unit selects one of the external instruments which is different from the particular external instrument, the control unit controllably displays the video information from the external instruments which is different from the particular external instrument on the display unit using a preset second video adjustment value and a preset second screen adjustment value.

3. The television receiver according to claim 2, wherein when the video information output by the particular external instrument is displayed on the display unit, the control unit shows, together with the video information, that the video information is displayed using the first video adjustment value.

4. The television receiver according to claim 3, wherein when the selection unit selects PC from the external instruments as the particular external instrument, the control unit controllably displays the video information on the display unit using the first video adjustment value and the first screen adjustment value.

5. The television receiver according to claim 1, wherein the connection unit is based on a communication scheme conforming to HDMI standards.

6. The television receiver according to claim 4, wherein the first screen adjustment value corresponds to a just scan mode, and the second screen adjustment value corresponds to an over scan mode.

7. A television display method comprising:
receiving, from each of external instruments connected via a network, standard compatibility information indicating whether or not the external instrument meets interdependent controllability standards and instrument type information specifying the type of the external instrument;
recording the standard compatibility information and the instrument type information in association with each of the external instruments;
when a particular external instrument is selected from the external instruments as an output source of video information to be displayed, displaying video information from the particular external instrument using a preset particular video adjustment value and a preset particular screen adjustment value.
